(19) United States
(12) Patent Application Publication
(10) Pub. No.: US 2009/0235281 A1
(43) Pub. Date: Sep. 17, 2009

(54) HANDHELD ELECTRONIC DEVICE, INPUT DEVICE AND METHOD THEREOF, AND DISPLAY DEVICE AND METHOD THEREOF

(75) Inventors: Chih-Kuo Lu, Taipei County (TW); Tsung-Cheng Yang, Taipei City (TW)

Correspondence Address: J C PATENTS, INC., 4 VENTURE, SUITE 250, IRVINE, CA, 92618, US

(73) Assignee: INVENTEC CORPORATION, Taipei City (TW)

(21) Appl. No.: 12/047,110

(22) Filed: Mar. 12, 2008

(51) Int. Cl. G06F 3/00

(52) U.S. Cl. 719/318

(57) ABSTRACT

A handheld electronic device, an input device and an input method thereof, and a display device and a display method thereof are provided. A display interface in the display device is divided into at least two portions so as to display the operation images of different application programs in the display interface at the same time. The operation images of the application programs are operated by using a single directional input interface of the input device. In the present invention, the function described above can be achieved without modifying the application programs by using only one touch screen including a display interface and a directional input interface. Thereby, the hardware cost of the handheld electronic device and the complexity for implementing the application programs of the handheld electronic device can be both reduced.

### BACKGROUND OF THE INVENTION

1. Field of the Invention

The present invention generally relates to a handheld electronic device, in particular, to an input device, an input method, a display device, and a display method for a handheld electronic device.

2. Description of Related Art

Along with the advancement of electronic technology, various handheld electronic devices integrated with many different application programs have been developed and brought into the market in order to meet consumers' requirements. Most of such handheld electronic devices have multiple functions having very complicated operating interfaces, and accordingly many input keys have to be disposed in order to allow users to operate these devices.

Generally speaking, the input keys for foregoing handheld electronic devices can be categorized into physical QWERTY keyboards or virtual keyboards displayed in touch screens. However, it can be easily understood that a physical QWERTY keyboards occupies a lot of space. In order to minimize the size of a handheld electronic device, the screen is even reduced to place the physical QWERTY keyboard, which causes inconvenience to users using the handheld electronic device. As to a virtual keyboard, it is incapable of keeping an area in the display screen for displaying the virtual keyboard, and besides, the application programs which are to be operated through the virtual keyboard have to be modified in order to display the virtual keyboard. For example, in the handheld electronic device illustrated in FIG. 1A, the resolution of the display screen for displaying the operation image of a primary application program is x*y, and physical keys A and B are disposed on the handheld electronic device. In a touch screen having the same resolution x*y, the application program has to be modified/designed by a program designer in order to render two virtual keys A and B having the same functions as the physical keys A and B through the application program, as shown in FIG. 1B. It is assumed here that the operation image of the application program of the virtual keys A and B occupies an area of x*z in the display screen. Thus, the operation image of the application program of the virtual keys A and B covers the operation image of the primary application program having a resolution of x*y. In addition, since the operation image of the application program having the virtual keys and the operation image of the primary application program overlap each other, the operation image of the primary application program may also overlap the operation image of the application program of the virtual keys during the operation, which is very inconvenient to the user. In order to avoid the overlapping between the operation image of the application program of the virtual keys and the operation image of the primary application program, the existing application programs of the handheld electronic device have to be modified, namely, the area for displaying the operation image of the primary application program has to be reduced in order to display the virtual keys A and B. Accordingly, while writing the application programs, the program designers have to adjust the resolution of the operation image of the primary application program into x*(y−z) in order to correctly display the operation images of the application programs in the screen. In other words, the same application program has to be modified differently regarding to every different handheld electronic device based on the resolution of the display screen and the size of the virtual keyboard (or the sizes of the virtual keys). Accordingly, the program designers have to spend extra time and energy in modifying the application programs and the modified application programs will be less flexible.

Another method for implementing a virtual keyboard in a handheld electronic device is illustrated in FIG. 1C, wherein two touch screens respectively having resolutions of x*y and x*z are disposed in the handheld electronic device, and these two touch screens are respectively used for displaying the operation image of a primary application program and the operation image of an application program of virtual keys A and B. FIG. 2 is a block diagram of an input device for the handheld electronic device. Referring to FIG. 2, the handheld electronic device 200 includes a primary touch screen 210 for displaying the operation image of the application program and a secondary touch screen 220 for displaying the virtual keyboard. When a user directly operates the primary application program, an input signal is generated by the primary touch screen 210 and then converted into a mouse event by a primary screen driving program 230, and the mouse event is sent to a first application program module 250 for driving the primary application program to execute a corresponding action. However, when the user is about to input text data, an input signal is generated by clicking at the virtual keyboard displayed in the secondary touch screen 220, and the input signal is converted into a keyboard event by a secondary screen driving program 240. The keyboard event is sent to a second application program module 260 for driving the application program of the virtual keyboard to execute a corresponding action. Additionally, the input signal may also be converted into a mouse event by the secondary screen driving program 240, and the mouse event may be sent to the first application program module 250 for driving the primary application program to execute a corresponding action.

FIG. 3 is a block diagram of a display device for foregoing handheld electronic device. The handheld electronic device 200 has a first image display module 310 and a second image display module 340. The first image display module 310 obtains an image data to be displayed in the primary touch screen 210 from the primary application program, and the second image display module 340 obtains an image data to be displayed in the secondary touch screen 220 from the application program of the virtual keyboard. The image data is respectively stored into a first temporary buffer 320 and a second temporary buffer 350 temporarily. After that, a first driving program 330 obtains the image data from the first temporary buffer 320 and displays the image data in the primary touch screen 210, and a second driving program 360 obtains the image data from the second temporary buffer 350 and displays the image data in the secondary touch screen 220.

As described above, by implementing a virtual keyboard with two touch screens, the hardware cost of the handheld electronic device is increased because of the additional touch screen, which will further increase the price of the handheld electronic device.

### SUMMARY OF THE INVENTION

Accordingly, the present invention is directed to an input device for a handheld electronic device, wherein an application program and a virtual keyboard are operated through the same input interface without modifying the application program.

The present invention is directed to an input method for a handheld electronic device, wherein an input signal is converted into a mouse event or a keyboard event according to the coordinates of the input signal, so as to drive different application program to execute different action according to the mouse event or keyboard event.

The present invention is directed to a display device for a handheld electronic device, wherein two different display images are simulated and displayed at the same time through one display interface so that the hardware cost of the display device is reduced.

The present invention is directed to a display method for a handheld electronic device, wherein an application program and a virtual keyboard are displayed through the same display interface without modifying the operation image of the application program.

The present invention is directed to a handheld electronic device, wherein different virtual keyboard is displayed according to the requirement of different application program so that the flexibility of the handheld electronic device is improved.

The present invention provides an input device for a handheld electronic device. The input device includes a directional input interface, a first application program module, a second application program module, and a judgment module. The directional input interface generates an input signal for controlling a first application program and/or a second application program which are executed at the same time. The first application program module triggers the first application program according to a first type interface event, and the second application program module triggers the second application program according to a second type interface event. The judgment module connected to the directional input interface, the first application program module, and the second application program module determines whether to send the input signal to the first application program module as the first type interface event or to the second application program module as the second type interface event according to the coordinates of the input signal.

The present invention provides an input method for a handheld electronic device, wherein the handheld electronic device executes a first application program and a second application program at the same time. The input method includes following steps. First, a first application program module is provided to trigger the first application program according to a first type interface event. Meanwhile, a second application program module is provided to trigger the second application program according to a second type interface event. After receiving the input signal through the directional input interface, whether to send the input signal to the first application program module as the first type interface event or to the second application program module as the second type interface event is determined according to the coordinates of the input signal.

The present invention provides a display device for a handheld electronic device. The display device includes a first image display module, a second image display module, a display interface, and a processing module. The first image display module obtains a first operation image of a first application program, and the second image display module obtains a second operation image of a second application program, wherein the second application program and the first application program are executed by the handheld electronic device at the same time. The display interface is used for displays an overall image data. The processing module is connected to the first image display module, the second image display module, and the display interface for integrating the first operation image and the second operation image into the overall image data according to a size of the display interface.

The present invention provides a display method for a handheld electronic device. The display method includes following steps. First, a first operation image of a first application program is obtained, and a second operation image of a second application program is obtained, wherein the first application program and the second application program are executed by the handheld electronic device at the same time. Next, the first operation image and the second operation image are integrated into an overall image data according to a size of the display interface, and the overall image data is displayed on the display interface.

The present invention provides a handheld electronic device. The handheld electronic device includes a touch display module, a first application program module, a second application program module, a judgment module, a first image display module, a second image display module, and a processing module. The touch display module includes a display interface for displaying an overall image data and a directional input interface for generating an input signal, wherein the input signal is used for controlling a first application program or a second application program which are executed at the same time. The first application program module triggers the first application program according to a first type interface event, and the second application program module triggers the second application program according to a second type interface event. The judgment module is connected to the directional input interface, the first application program module, and the second application program module for determining whether to send the input signal to the first application program module as the first type interface event or to the second application program module as the second type interface event according to the coordinates of the input signal. The first image display module obtains a first operation image of the first application program, and the second image display module obtains a second operation image of the second application program. The processing module is connected to the first image display module, the second image display module, and the display interface for integrating the first operation image and the second operation image into the overall image data according to a size of the display interface.

In the present invention, one display interface is divided into two portions, wherein the first portion is used for displaying an application program, and the other portion is used for displaying a virtual keyboard. In addition, the operations performed to the application program and the virtual keyboard are received through one input interface. Accordingly, the original operation interface of the application program can be kept at the same time, and different virtual keyboards can be presented according to the requirement of the application program. Thereby, the combination flexibility between the application program and the virtual keyboard is increased without modifying the application program or adding any additional hardware, and accordingly the hardware cost is reduced.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A, 1B, and 1C are respectively diagrams of conventional handheld electronic devices.

FIG. 2 is a block diagram of an input device for a conventional handheld electronic device.

FIG. 3 is a block diagram of a display device for a conventional handheld electronic device.

FIG. 4 is a block diagram of an input device for a handheld electronic device according to an embodiment of the present invention.

FIG. 5 is a flowchart of an input method for a handheld electronic device according to an embodiment of the present invention.

FIG. 6 is a block diagram of a display device for a handheld electronic device according to an embodiment of the present invention.

FIG. 7 is a flowchart of a display method for a handheld electronic device according to an embodiment of the present invention.

FIG. 8 is a diagram of a handheld electronic device according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In make the features, aspects, and advantages of the present invention more apparent, embodiments of the present invention will be described below with reference to accompanying drawings.

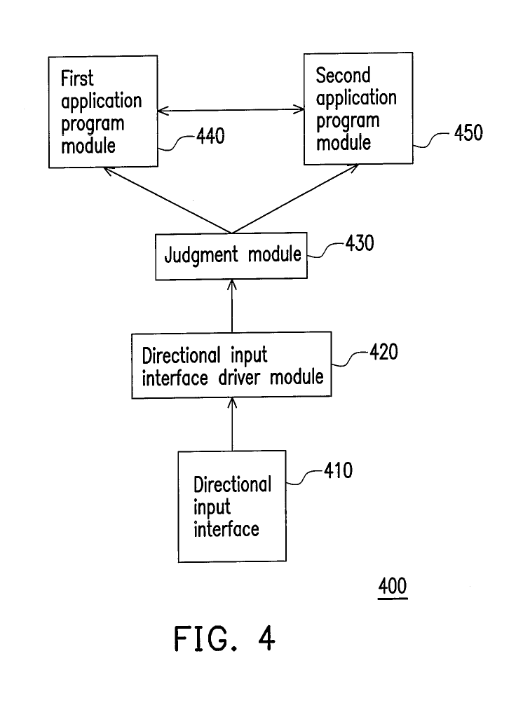

FIG. 4 is a block diagram of an input device for a handheld electronic device according to an embodiment of the present invention. Referring to FIG. 4, the input device 400 for a handheld electronic device includes a directional input interface 410, a directional input interface driver module 420, a judgment module 430, a first application program module 440, and a second application program module 450. The input device 400 may be disposed in a handheld electronic device, such as a cell phone, a smart phone, or a personal digital assistant (PDA), and the application scope of the input device 400 is not limited in the present invention.

The directional input interface 410 is, for example, a touch panel which can generate an input signal according to the operation of a user, wherein the input signal is used for controlling a first application program and/or a second application program executed by the handheld electronic device at the same time. For example, the second application program includes an application program of a virtual keyboard, and the first application program may be a primary application program supported by the operating system of the handheld electronic device (for example, a desktop management program, an email application program, or a web browser application program in Windows CE). In the present embodiment, a first operation image corresponding to the first application program and a second operation image corresponding to the second application program may be displayed in a display interface (not shown) of the handheld electronic device at the same time; however, the present invention is not limited to foregoing display pattern.

The directional input interface driver module 420 converts the input signal into a mouse event, and which determines the type of the input signal and obtains the coordinates thereof. In the present embodiment, the directional input interface driver module 420 may be an input interface driver installed in a graphic window event system (GWES) of the handheld electronic device, and which converts the input signal into a moue event (for example, LButtonDown, LButtonUp, or LButtonDBClick) according to the operation of the user.

The first application program module 440 in the input device 400 triggers the first application program according to a first type interface event (for example, the mouse event), and the second application program module triggers the second application program according to a second type interface event (for example, a keyboard event).

The judgment module 430 connected to the directional input interface driver module 420, the first application program module 440, and the second application program module 450 respectively, for determining whether to send the input signal to the first application program module 440 as the first type interface event or to the second application program module 450 as the second type interface event according to the coordinates of the input signal obtained by the directional input interface driver module 420.

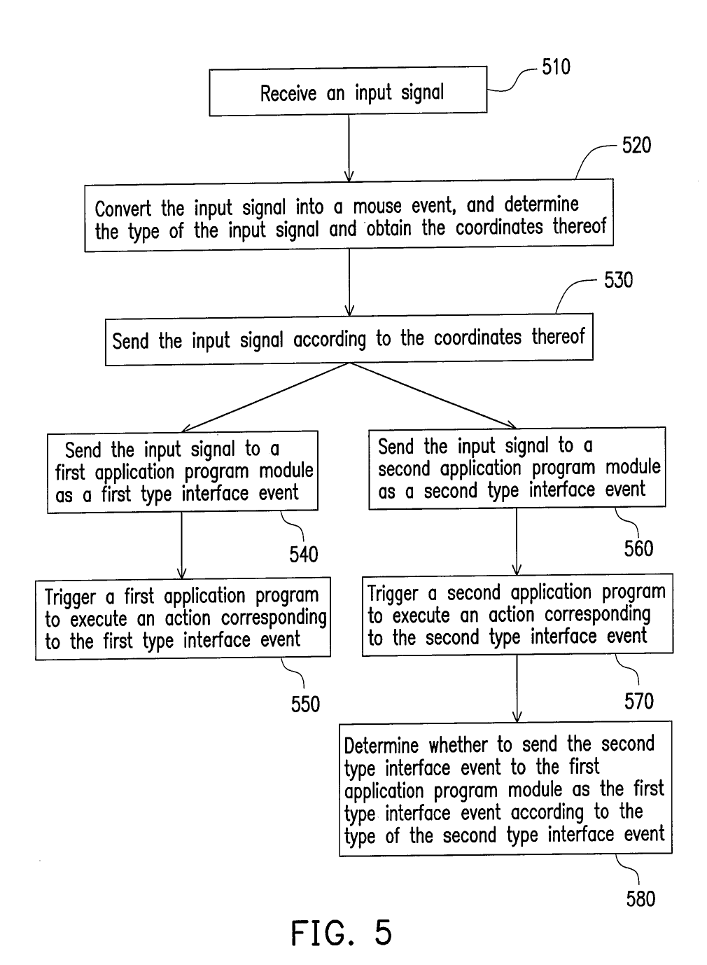

Another embodiment of the present invention will be described herein in order to explain the operation procedure of the input device 400 for a handheld electronic device. FIG. 5 is a flowchart of an input method for a handheld electronic device according to the present embodiment. Referring to both FIG. 4 and FIG. 5, a first application program and a second application program are executed simultaneously in the handheld electronic device. A first application program module 440 which triggers the first application program according to a first type interface event, and a second application program module 450 which triggers the second application program according to a second type interface event are provided. For the convenience of description, it is assumed that the first application program is an email application program, and the second application program is a virtual keyboard application program.

In step 510, when a user operates the handheld electronic device, the handheld electronic device receives an input signal corresponding to the operation of the user through the directional input interface 410. Next, in step 520, the directional input interface driver module 420 converts the input signal into a mouse event and obtains the coordinates of the input signal while determining which type of mouse event the input signal belongs to.

In step 530, after the directional input interface driver module 420 obtains the coordinates of the input signal, the judgment module 430 sends the input signal according to the coordinates thereof. In the present embodiment, it is assumed that a first operation image corresponding to the first application program and a second operation image corresponding to the second application program are displayed in a display interface (not shown) of the handheld electronic device at the same time, and then the judgment module 430 determines whether to send the input signal to the first application program module 440 or the second application program module 450 according to the coordinates of the input signal, and the respectively display areas of the first operation image and the second operation image on the display interface.

To be specific, if the coordinates of the input signal are corresponding to the display area of the first operation image on the display interface, then in step 540, the judgment module 430 sends the input signal to the first application program module 440 as the first type interface event, and in step 550, the first application program module 440 triggers the first application program to execute an action corresponding to the first type interface event (for example, sending an email).

However, if the coordinates of the input signal are corresponding to the display area of the second operation image on the display interface, then in step 560, the judgment module 430 sends the input signal to the second application program module 450 as the second type interface event, and in step 570, the second application program module 450 triggers the second application program to execute an action corresponding to the second type interface event. Since the second application program is assumed to be a virtual keyboard application program in the present embodiment, the second application program module 450 further determines whether to send the second type interface event to the first application program module 440 as the first type interface event according to the type of the second type interface event besides executing the action. For example, if the user presses a “confirm” key on the virtual keyboard, the second type interface event generated by pressing the “confirm” key has to be sent to the first application program module 440 to be converted into a first type interface event for driving the email application program to execute a confirm action. In other words, the user may trigger a first application program (for example, the email application program) to execute an action through a second application program (for example, the virtual keyboard application program).

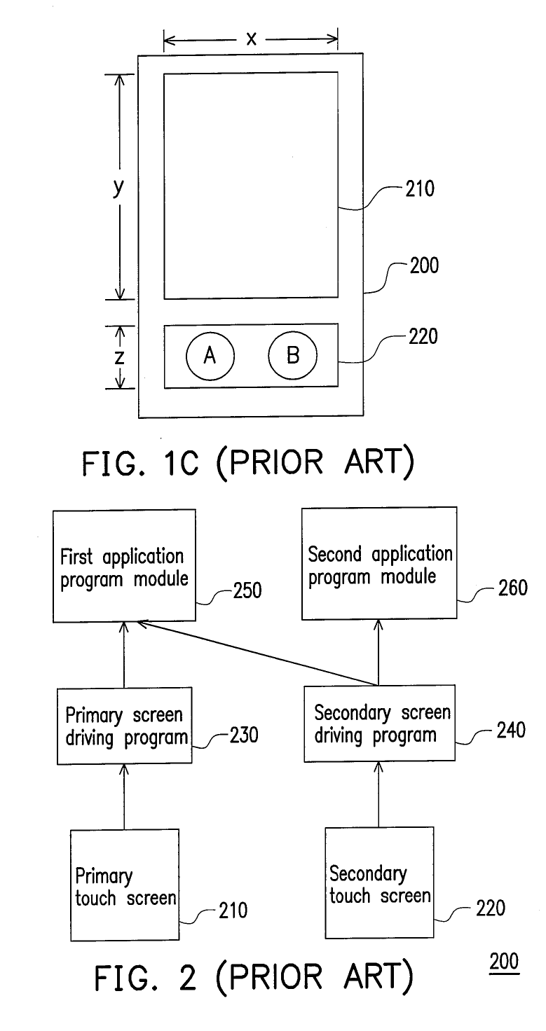

It can be understood by comparing FIG. 2 and FIG. 4 that in the present invention, with only one directional input interface 410, an input signal can be sent by the judgment module 430 according to the coordinates of the input signal to operate a general application program and a virtual keyboard application program which are simultaneously executed in the handheld electronic device. Accordingly, the space for disposing physical keys on the handheld electronic device can be saved and the convenience of using the handheld electronic device can be improved.

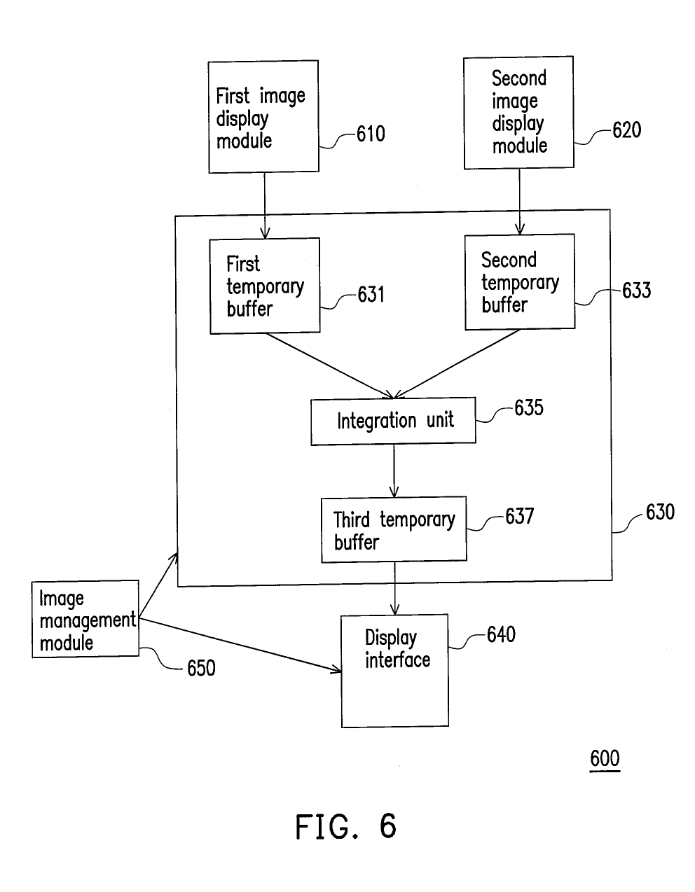

FIG. 6 is a block diagram of a display device for a handheld electronic device according to an embodiment of the present invention. Referring to FIG. 6, in the present embodiment, the display device 600 for a handheld electronic device includes a first image display module 610, a second image display module 620, a processing module 630, a display interface 640, and an image management module 650.

In the present embodiment, the first image display module 610 and the second image display module 620 are, for example, the display drivers in a GWES module, and which are respectively used for obtaining a first operation image of a first application program and a second operation image of a second application program. Because of these two image display modules, the operating system of the handheld electronic device considers that the handheld electronic device has two different display screens which can be used for respectively displaying the operation images of different application programs. However, it should be noted that in the present embodiment, there is actually only one display interface 640 (for example, a touch screen) for displaying an overall image data.

The processing module 630 includes a first temporary buffer 631, a second temporary buffer 633, an integration unit 635, and a third temporary buffer 637. The first temporary buffer 631 temporarily stores the first operation image obtained by the first image display module 610, and the second temporary buffer 633 temporarily stores the second operation image obtained by the second image display module 620. The integration unit 635 integrates the first operation image and the second operation image into an overall image data according to the size of the first operation image, the size of the second operation image, and the size of the display interface 640. In the present embodiment, the overall image data may be temporarily stored into the third temporary buffer 637 before it is displayed in the display interface 640.

The image management module 650 is connected to both the processing module 630 and the display interface 640 for obtaining the integrated overall image data from the processing module 630 and sending the overall image data to the display interface 640 so that the operation images of the two application programs can be displayed on the display interface 640 at the same time.

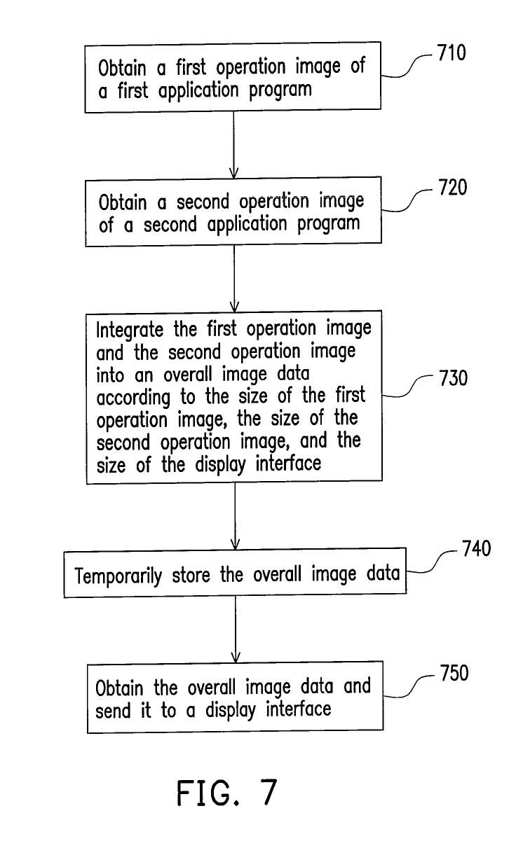

The detailed steps of simulating two display screens in the display interface 640 of a handheld electronic device will be described in following embodiment. Referring to both FIG. 6 and FIG. 7, first, in step 710 and step 720, a first operation image of the first application program is obtained by the first image display module 610, and a second operation image of the second application program is obtained by the second image display module 620. The second application program may be an application program of a virtual keyboard, and the first application program includes various application programs supported by the operating system of the handheld electronic device. The first operation image and the second operation image are temporarily stored into the first temporary buffer 631 and the second temporary buffer 633 in the processing module 630.

Next, in step 730, the integration unit 635 integrates the first operation image and the second operation image into an overall image data according to the size of the first operation image, the size of the second operation image, and the size of the display interface 640. In the present embodiment, after the integration unit 635 obtains the first operation image and the second operation image from the first temporary buffer 631 and the second temporary buffer 633, the integration unit 635 first determines whether or not the size of the two operation images directly integrated matches the size of the display interface 640. If the size of the directly integrated operation images matches the size of the display interface 640, the integration unit 635 directly integrates the first operation image and the second operation image. If the size of the directly integrated operation images does not match the size of the display interface 640, the integration unit 635 adjusts the size (resolution) of the first operation image or the second operation image before integrating the two operation images so as to ensure the size of the integrated overall image data can match the size of the display interface 640. Next, in step 740, the integration unit 635 temporarily stores the overall image data having a size matching the size of the display interface 640 into the third temporary buffer 637.

In step 750, the image management module 650 obtains the overall image data from the processing module 630 and sends it to the display interface 640 to be displayed. In an embodiment of the present invention, the transmission rate of the overall image data can be increased by adopting a direct memory access (DMA) controller so as to improve the efficiency of the entire handheld electronic device.

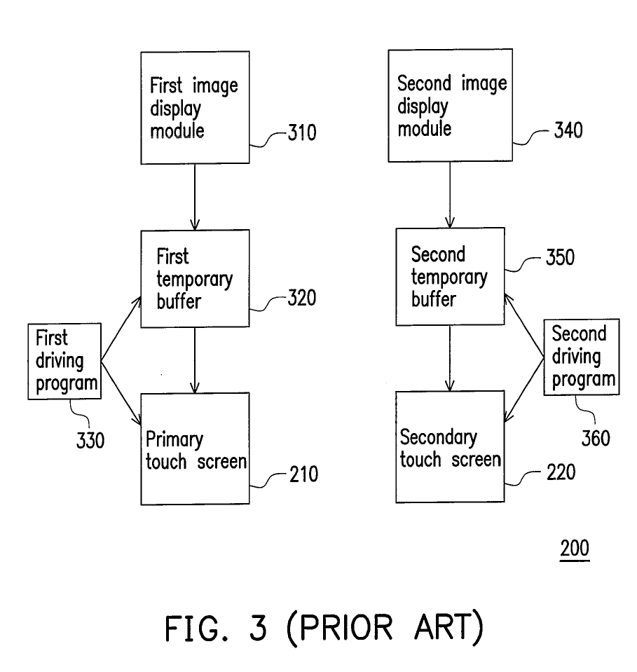

Unlike the display device for a conventional handheld electronic device illustrated in FIG. 3, in the display device 600 for the handheld electronic device in the present embodiment, two display screens can be simulated by using a single display interface to display the operation images of two different application programs, and at the same time, the original operation interfaces of the application programs can be kept without modifications. Accordingly, the hardware cost for disposing multiple display screens in the handheld electronic device can be saved and the complexity for writing the application programs can be reduced.

In an embodiment of the present invention, any handheld electronic device having a touch display module (for example, a cell phone, a smart phone, or a PDA) can be disposed with foregoing input device 400 and display device 600 to simulate two display screens by using a single display interface in the touch display module through the input method and display method described above, and to operate two application programs executed at the same time through a single directional input interface in the touch display module so as to simulate physical keys by using the directional input interface (that is, the function of the virtual keyboard can be implemented by the single directional input interface thereof). However, the input method and display method for the handheld electronic device in the present embodiment have the same or similar procedures as those in foregoing embodiment therefore will not be described herein.

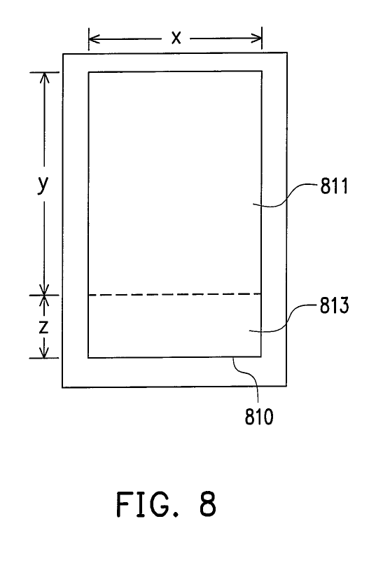

It should be mentioned that the appearance of a handheld electronic device disposed with both the input device and the display device described above is as illustrated in FIG. 8. Referring to FIG. 8, the handheld electronic device has a touch display module 810 (for example, a touch screen) having a resolution of x*(y+z), and the touch display module 810 includes a first display area 811 and a second display area 813. The first display area 811 displays the operation image of a general application program, and the second display area 813 displays different types of virtual keyboards along with different application programs.

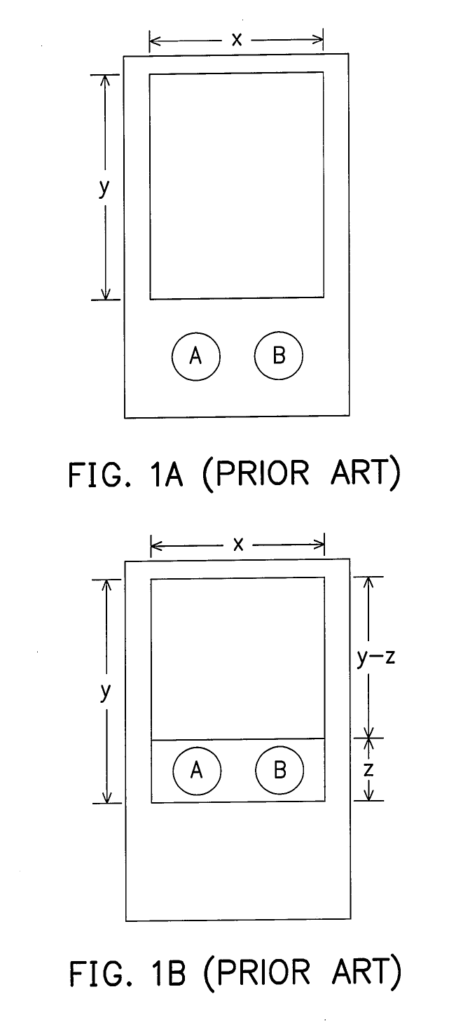

It can be understood by comparing FIG. 8 and FIG. 1B that because the operating system (for example, Windows CE) of the handheld electronic device has set its limitation to the resolution of the operation image, the resolution of the touch screen cannot be changed randomly according to the design requirement. Thus, conventionally, a virtual keyboard is implemented through a “window” technique as illustrated in FIG. 1B. Namely, the operating system considers that there is only one display screen (operation desktop) in the handheld electronic device.

Regarding a handheld electronic device implemented according to an embodiment of the present invention (as shown in FIG. 8), the operating system considers that there are two different display screens in the handheld electronic device. In other words, in a handheld electronic device in an embodiment of the present invention, a plurality of display screens can be simulated by using a single touch screen 810, and at the same time, the touch screen 810 is also used for simulating a directional input device and physical keys. Thus, the resolution of the touch screen 810 in FIG. 8 can be changed freely according to the design requirement. For example, in the present embodiment, a first display area 811 having a size of x*y is specified in the touch screen 810 according to the specification of the operating system, and the first display area 811 is used by the operating system for displaying an operation image thereof (including the operation desktop and images of various application programs) and is used as a directional input device of the operation image. The remaining portion (a second display area 813 having the size of x*z) is used for simulating another display screen (for example, for displaying the operation image of a virtual keyboard) and is used as an input device of the virtual keyboard.

Accordingly, in the embodiment illustrated in FIG. 8, the space for displaying the operation image of the primary application program does not need to be reduced. In other words, any application program executed in the handheld electronic device illustrated in FIG. 1A can also be executed in the handheld electronic device illustrated in FIG. 8, and the operation image thereof can be directly displayed in the first display area 811 without any modification. A user can also simulate the physical keys A and B in FIG. 1A by using a virtual keyboard displayed in the second display area 813 in order to operate the application program. Compared to the handheld electronic device illustrated in FIG. 1C, the handheld electronic device in FIG. 8 can display the operation images of different application programs by using a single touch display module 810, and accordingly the hardware cost of the handheld electronic device can be greatly reduced.

In summary, the handheld electronic device and the input and display devices and methods thereof provided by the present invention have at least following advantages:
1. an existing display interface is divided into at least two portions so that an application program and a virtual keyboard can be displayed and operated at the same time through the operation of a single directional input interface. Accordingly, the space for disposing a physical keyboard can be saved and the convenience in using the handheld electronic device can be increased by enlarging the display area.
2. the original operation interface of an application program is kept without modifying the application program so that the application program and a virtual keyboard can be displayed through a single display interface. Accordingly, the complexity for implementing the application program of the handheld electronic device is reduced.
3. different virtual keyboards can be presented along with different application programs without modifying the application programs, and a virtual keyboard may even be customized according to the requirement of a user. Accordingly, the flexibility in using the handheld electronic device is improved.
4. two display screens can be simulated by using only one display interface. Accordingly, the hardware cost for fabricating the display screen of the handheld electronic device can be reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An input device for a handheld electronic device, comprising:
a directional input interface, for generating an input signal to control a first application program and/or a second application program executed at the same time;
a first application program module, for triggering the first application program according to a first type interface event;
a second application program module, for triggering the second application program according to a second type interface event; and
a judgment module, coupled to the directional input interface, the first application program module, and the second application program module, for determining whether to send the input signal to the first application program module as the first type interface event or to the second application program module as the second type interface event according to a plurality of coordinates of the input signal.

2. The input device according to claim 1, further comprising:
a directional input interface driver module, coupled between the directional input interface and the judgment module for converting the input signal into a mouse event so as to determine a type of the input signal and obtain the coordinates of the input signal.

3. The input device according to claim 1, further comprising:
a display interface, for simultaneously displaying a first operation image corresponding to the first application program and a second operation image corresponding to the second application program.

4. The input device according to claim 3, wherein the judgment module determines whether to send the input signal to the first application program module or the second application program module according to the coordinates of the input signal and display areas relative to the first operation image and the second operation image on the display interface.

5. The input device according to claim 1, wherein the first application program module triggers the first application program to execute an action corresponding to the first type interface event.

6. The input device according to claim 1, wherein the second application program module triggers the second application program to execute an action corresponding to the second type interface event.

7. The input device according to claim 6, wherein the second application program determines whether to send the second type interface event to the first application program module as the first type interface event according to the type of the second type interface event after executing the action.

8. The input device according to claim 1, wherein the second application program comprises an application program of a virtual keyboard, and the first application program comprises an application program supported by an operating system of the handheld electronic device.

9. The input device according to claim 1, wherein the first type interface event comprises a mouse event, and the second type interface event comprises a keyboard event.

10. The input device according to claim 1, wherein the directional input interface comprises a touch panel.

11. An input method for a handheld electronic device, suitable for a handheld electronic device executes a first application program and a second application program at the same time, the input method comprising:
providing a first application program module for triggering the first application program according to a first type interface event;
providing a second application program module for triggering the second application program according to a second type interface event;
receiving an input signal through a directional input interface; and
determining whether to send the input signal to the first application program module as the first type interface event or to the second application program module as the second type interface event according to a plurality of coordinates of the input signal.

12. The input method according to claim 11, further comprising:
converting the input signal into a mouse event so as to determine the type of the input signal and obtain the coordinates of the input signal.

13. The input method according to claim 11, further comprising:
displaying a first operation image corresponding to the first application program and a second operation image corresponding to the second application program on a display interface at the same time.

14. The input method according to claim 13, wherein the step of sending the input signal according to the coordinates of the input signal comprises:
determining whether to send the input signal to the first application program module or to the second application program module according to the coordinates of the input signal and display areas relative to the first operation image and the second operation image on the display interface.

15. The input method according to claim 11, further comprising:
triggering the first application program to execute an action corresponding to the first type interface event.

16. The input method according to claim 11, further comprising:
triggering the second application program to execute an action corresponding to the second type interface event.

17. The input method according to claim 16, further comprising:
determining whether to send the second type interface event to the first application program module as the first type interface event according to the type of the second type interface event.

18. The input method according to claim 11, wherein the second application program comprises an application program of a virtual keyboard, and the first application program comprises an application program supported by an operating system of the handheld electronic device.

19. The input method according to claim 11, wherein the first type interface event comprises a mouse event, and the second type interface event comprises a keyboard event.

20. The input method according to claim 11, wherein the directional input interface comprises a touch panel.

21. A display device for a handheld electronic device, comprising:
a first image display module, for obtaining a first operation image of a first application program;
a second image display module, for obtaining a second operation image of a second application program, wherein the second application program and the first application program are executed simultaneously on the handheld electronic device;
a display interface, for displaying an overall image data; and
a processing module, coupled to the first image display module, the second image display module, and the display interface, for integrating the first operation image and the second operation image into the overall image data according to a size of the display interface.

22. The display device according to claim 21, wherein the processing module further comprises:
a first temporary buffer, coupled to the first image display module for temporarily storing the first operation image;
a second temporary buffer, coupled to the second image display module for temporarily storing the second operation image; and
an integration unit, coupled to the first temporary buffer and the second temporary buffer, for integrating the first operation image and the second operation image into the overall image data according to the a of the first operation image, a size of the second operation image, and the size of the display interface.

23. The display device according to claim 22, wherein the integration unit calculates an integrated size of the first operation image and the second operation image, adjusts the first operation image or the second operation image if the integrated size does not match the size of the display interface, and integrates the first operation image and the second operation image into the overall image data.

24. The display device according to claim 22, wherein the processing module further comprises:
a third temporary buffer, coupled to the integration unit and the display interface, for temporarily storing the overall image data.

25. The display device according to claim 22, further comprising:
an image management module, coupled to the processing module and the display interface, for obtaining the overall image data from the processing module and sending the overall image data to the display interface.

26. The display device according to claim 21, wherein the second application program comprises an application program of a virtual keyboard, and the first application program comprises an application program supported by an operating system of the handheld electronic device.

27. The display device according to claim 21, wherein the display interface comprises a touch screen.

28. A display method for a handheld electronic device, the display method comprising:
obtaining a first operation image of a first application program;
obtaining a second operation image of a second application program, wherein the first application program and the second application program are executed simultaneously on the handheld electronic device;
integrating the first operation image and the second operation image into an overall image data according to a size of a display interface; and
displaying the overall image data in the display interface.

29. The display method according to claim 28, wherein the step of integrating the first operation image and the second operation image into the overall image data comprises:
integrating the first operation image and the second operation image into the overall image data according to a size of the first operation image, a size of the second operation image, and the size of the display interface.

30. The display method according to claim 28, wherein the step of integrating the first operation image and the second operation image into the overall image data comprises:
determining whether an integrated size of the first operation image and the second operation image matches the size of the display interface;
adjusting the first operation image or the second operation image if the integrated size does not match the size of the display interface; and
integrating the first operation image and the second operation image into the overall image data.

31. The display method according to claim 28, wherein after the step of integrating the first operation image and the second operation image into the overall image data, the display method comprises:
temporarily storing the overall image data.

32. The display method according to claim 28, wherein the step of displaying the overall image data in the display interface comprises:
obtaining the overall image data; and
sending the overall image data to the display interface.

33. The display method according to claim 28, wherein the second application program comprises an application program of a virtual keyboard, and the first application program comprises an application program supported by an operating system of the handheld electronic device.

34. The display method according to claim 28, wherein the display interface comprises a touch screen

35. A handheld electronic device, comprising:
a touch display module, comprising:
a display interface, for displaying an overall image data; and
a directional input interface, for generating an input signal, wherein the input signal is used for controlling a first application program or a second application program executed at the same time.
a first application program module, for triggering the first application program according to a first type interface event;
a second application program module, for triggering the second application program according to a second type interface event;
a judgment module, coupled to the directional input interface, the first application program module, and the second application program module, for determining whether to send the input signal to the first application program module as the first type interface event or to the second application program module as the second type interface event according to a plurality of coordinates of the input signal;
a first image display module, for obtaining a first operation image of the first application program;
a second image display module, for obtaining a second operation image of the second application program; and
a processing module, coupled to the first image display module, the second image display module, and the display interface, for integrating the first operation image and the second operation image into the overall image data according to a size of the display interface.

36. The handheld electronic device according to claim 35, wherein the processing module further comprises:
a first temporary buffer, coupled to the first image display module for temporarily storing the first operation image;
a second temporary buffer, coupled to the second image display module for temporarily storing the second operation image; and
an integration unit, coupled to the first temporary buffer and the second temporary buffer, for integrating the first operation image and the second operation image into the overall image data according to a size of the first operation image, a size of the second operation image, and the size of the display interface.

37. The handheld electronic device according to claim 36, wherein the integration unit calculates an integrated size of the first operation image and the second operation image, adjusts the first operation image or the second operation image if the integrated size does not match the size of the display interface, and integrates the first operation image and the second operation image into the overall image data.

38. The handheld electronic device according to claim 35, wherein the processing module further comprises:
a third temporary buffer, coupled to the integration unit and the display interface for temporarily storing the overall image data.

39. The handheld electronic device according to claim 35, further comprising:
an image management module, coupled to the processing module and the display interface, for obtaining the overall image data from the processing module and sending the overall image data to the display interface.

40. The handheld electronic device according to claim 35, further comprising:
a directional input interface driver module, coupled to the directional input interface and the judgment module for converting the input signal into a mouse event so as to determine a type of the input signal and obtain the coordinates of the input signal.

41. The handheld electronic device according to claim 35, wherein the judgment module determines whether to send the input signal to the first application program module or to the second application program module according to the coordinates of the input signal and display areas relative to the first operation image and the second operation image on the display interface.

42. The handheld electronic device according to claim 35, wherein the first application program module triggers the first application program to execute an action corresponding to the first type interface event.

43. The handheld electronic device according to claim 35, wherein the second application program module triggers the second application program to execute an action corresponding to the second type interface event.

44. The handheld electronic device according to claim 43, wherein the second application program determines whether to send the second type interface event to the first application program module as the first type interface event according to the type of the second type interface event after executing the action.

45. The handheld electronic device according to claim 35, wherein the second application program comprises an application program of a virtual keyboard, and the first application program comprises an application program supported by an operating system of the handheld electronic device.

46. The handheld electronic device according to claim 35, wherein the first type interface event comprises a mouse event, and the second type interface event comprises a keyboard event.

47. The handheld electronic device according to claim 35, wherein the directional input interface comprises a touch panel, and the display interface comprises a touch screen.
